(19) United States
(12) Patent Application Publication
(10) Pub. No.: US 2013/0049669 A1
(43) Pub. Date: Feb. 28, 2013

(54) METHOD OF CONTROLLING POSITION OF SEAT USING SINGLE HALL SENSOR

(71) Applicant: Seung Su HAN, Seoul (KR)

(72) Inventor: Seung Su HAN, Seoul (KR)

(73) Assignees: KIA MOTORS CORPORATION, Seoul (KR); HYUNDAI MOTOR COMPANY, Seoul (KR)

(21) Appl. No.: 13/313,906

(22) Filed: Dec. 7, 2011

(30) Foreign Application Priority Data
Aug. 23, 2011 (KR) 10-2011-0083882

(51) Int. Cl. G05B 23/02

(52) U.S. Cl. 318/565

(57) ABSTRACT

A method of controlling a position of a seat using a single hall sensor. A pulse is output from the hall sensor in response to the rotation of the motor when displacing the seat forward or backward. The rotation of the motor is controlled such that the pulse output from the hall sensor is put in a sensor error state. It is determined whether or not the pulse output from the hall sensor is in the sensor error state. A sensor error is generated if the pulse output from the hall sensor is not in the sensor error state in the error state check step.

### CROSS-REFERENCE TO RELATED APPLICATION

This application claims under 35 U.S.C. §119(a) the benefit of Korean Patent Application No. 10-2011-0083882 filed on Aug. 23, 2011 in the Korean Intellectual Property Office, the entire contents of which are incorporated herein by reference.

### BACKGROUND

1. Field of the Invention

The present invention relates, in general, to a method of controlling the position of a seat using a single hall sensor, in which the position of the seat of a driver or a steering column is memorized and a driving position is automatically reinstated.

2. Description of the Related Art

In general, when several drivers share one automobile, an automatic memory seat for the automobile has the function of memorizing an optimal position of the seat for the figure or stature of a respective driver, and has the function of displacing the seat to a position depending on the figure or stature of a driver when a position control button is used to input into memory after the driver has configured the seat.

Typically, an automatic seat is operated by mounting a small direct current (DC) motor on a sliding mechanism, a tilt-and-height mechanism or a recliner mechanism depending on the purpose of the object. An automatic seat having a memory position control function needs to detect the number of rotations of the motor in order to control its position. For this, a ring magnet and a lead switch or a hall sensor, which rotate together with a rotary shaft of the motor, are used.

However, the motor, which is realized as above, is configured in such a fashion that only the position of the automatic seat in a power seat control unit is controlled by only counting pulse waveforms, which are generated from the hall sensor or the lead switch. Consequently, it is impossible to determine the direction of an advancing operation, such as the forward and backward motion of the slide, the upward and downward motion of the tilt-and-height and/or the upward and downward motion of the recliner. Consequently, in order to limit the stroke of the seat, a separate limit switch or a stopper, which mechanically and forcibly restrains the seat, must be mounted therein.

However, the mounting of the limit switch may increase the manufacturing costs, since it is relatively expensive. In addition, the stopper, which mechanically and forcibly restrains the automatic seat, may damage the motor and the seat mechanism, thereby lowering the durability of the automatic seat, if forced restraint is repeated for a long time. There is also a problem in that an impact, which occurs when the stopper restrains the seat, may make the occupants uncomfortable as well.

The information disclosed in this Background of the Invention section is only provided to enhance the understanding of the background of the invention, and should not be taken as an acknowledgment or any form of suggestion that this information forms a prior art that would already be known to a person skilled in the art.

### SUMMARY

Accordingly, the present invention has been made keeping in mind the above problems occurring in the related art, and the present invention is intended to propose a method of controlling the position of a seat using a single hall sensor, in which a sensor error disregard section is applied to the end of sections of the operation of each motor, so that a sensor error that occurs within the sensor error disregard section is disregarded and the present position is updated to be the limit position.

In order to achieve the above object, according to one aspect of the present invention, there is provided a method of controlling a position of a seat using a single hall sensor. The method includes outputting a pulse from the hall sensor in response to the rotation of the motor when displacing the seat forward or backward controlling the rotation of the motor such that the pulse output from the hall sensor is put in a sensor error state; checking whether or not the pulse output from the hall sensor is in the sensor error state; and generating a sensor error if the pulse output from the hall sensor is not in the sensor error state in the error state check step. More specifically, the sensor error state may define that the pulse output from the hall sensor is within 6 pulses.

The method may further include applying a sensor error disregard section to a respective end of sections of an operation of the motor; checking whether or not a present position is between the sections of the operation of the motor, when the seat is in a forward or backward displacement because the pulse, which is not in the sensor error state, is not output while checking the error state; and when the present position is in the sensor error disregard section instead of being between the sections of the operation of the motor and the pulse, which is not in the sensor error state, is output, setting the present position to be a limit position by disregarding the sensor error, and automatically determining an opposite limit position by applying a predetermined stroke distance.

According to the method of controlling the position of a seat using a single hall sensor as set forth above, it is possible to decrease the number of hall sensors of the motor thereby reducing the manufacturing cost, and to prevent any problems that would otherwise be caused by a single hall sensor, thereby ensuring reliability. In addition, it is possible to update the present position to be the limit position by disregarding the sensor error in the sensor error disregard section and automatically updating the opposite limit by applying a predetermined stroke distance without installing a limit switch.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a flowchart showing a method of controlling the position of a seat using a single hall sensor according to an exemplary embodiment of the present invention.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

With reference to the accompanying drawing, a description will be given below of a method of controlling the position of a seat using a single hall sensor according to an embodiment of the present invention.

The method of controlling the position of a seat using a single hall sensor according to of this embodiment of the present invention is a method of controlling the position of a seat depending on the rotation of a motor using a single hall sensor, and may include a pulse output step S100 of outputting a pulse from the hall sensor in response to the rotation of the motor when displacing the seat forward or backward, a motor control step S200 of controlling the rotation of the motor such that the pulse output from the hall sensor is put in a sensor error state, an error state check step S300 of checking whether or not the pulse output from the hall sensor is in the sensor error state, and a sensor error generation step S400 of generating a sensor error if the pulse output from the hall sensor is not in the sensor error state.

Here, the sensor error state is designed to control the operation of the motor so that the pulse output from the hall sensor becomes within 6 pulses so as not to reach the mechanical end of the sections of operation when the motor rotates. This is intended to control the motor so that the motor stops before the 6 pulses so as not to reach the mechanical end, cooperation with getting in/out of the automobile, and being operated by a manual switch.

Although the sensor error state is set so that the motor stops before the 6 pulses, a cumulative error occurs during a movement in the reverse direction because of inertia by gravity when the motor stops. Because of this cumulative error, an error greater than the 6 pulses may occur even though the motor is designed to turn off before the 6 pulses. Then, the sensor error is generated. If an output in the error state check step S300 is in the sensor error state, the seat is displaced forwards or backwards in response to the rotation of the motor.

The method also includes an operation section check step S600 of checking whether or not the present position is between certain sections of the operation of the motor in the forward or backward displacement of the seat, a sensor error disregard section application step S500 of applying a sensor error disregard section to the end of the certain sections of the operation of the motor, which is installed in each seat, and a limit position determination step S700 of setting, when the pulse that is not in the sensor error state is output from the sensor error disregard section, the present position to be a limit position by disregarding a sensor error, and automatically determining an opposite limit position by applying a predetermined stroke distance. This makes it possible to set the limit of the sections of the operation of the motor without using a limit switch so that the forward or backward motion of the motor can be controlled by determining the limit position of the motor in the sensor error disregard section.

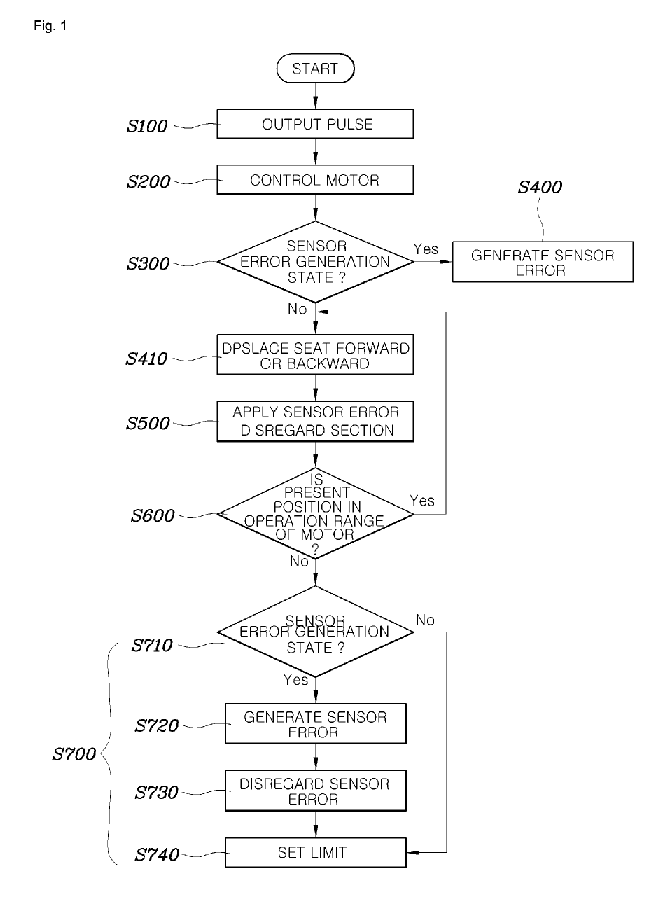

FIG. 1 is a flowchart of the method of controlling the position of a seat using a single hall sensor according to an exemplary embodiment of the present invention. In S100, the motor is operated to rotate by the manual switch, thereby displacing the position of the seat forward or backward, and the hall sensor outputs a pulse in response to the rotation of the motor. In S200, the rotation of the motor is controlled so that the pulse is output in the sensor error state from the hall sensor. Afterwards, the error state check step S300 is performed to check whether or not the pulse output from the hall sensor is in the sensor error state. If it is determined, in the error state check step S300, that the output pulse is not in the sensor error state, the sensor error generation step S400 is performed to generate a sensor error. If the output pulse is in the sensor error state, the seat is displaced forward or backward in S410.

The range of forward or backward displacement of the seat is limited. For this, the sensor error disregard section is applied to each end of the sections of the operation of the motor in S500. Afterwards, the step S600 of checking whether or not the present position is between the sections of the operation of the motor is performed. If it is determined, in the operation section check step, that the present position is in the sensor error disregard section instead of being between the sections of the operation of the motor, it is checked whether or not the pulse, which is not in the sensor error state, is being output in S710. If the pulse, which is not in the sensor error state, is not being output, the present position is set as the limit position in S740. If the pulse, which is not in the sensor error state, is being output, a sensor error is generated in S720. When the sensor error is generated, the sensor error is disregarded in S730. The present position is determined as the limit position, and the opposite limit position is automatically determined by applying the predetermined stroke distance in S740.

Accordingly, it is possible to set the current position as the limit position by disregarding the sensor error in the sensor error disregard section without installing the limit switch, and thus to effectively control the displacement of the seat within the limited range.

Although the exemplary embodiments of the present invention have been described for illustrative purposes, a person skilled in the art will appreciate that various modifications, additions and substitutions are possible, without departing from the scope and spirit of the invention as disclosed in the accompanying claims.

What is claimed is:

1. A method of controlling a position of a seat using a single hall sensor, comprising:
outputting a pulse from the hall sensor in response to a rotation of a motor when displacing the seat forward or backward;
controlling the rotation of the motor such that the pulse output from the hall sensor is put in a sensor error state;
determining whether or not the pulse output from the hall sensor is in the sensor error state; and
in response to determining that the hall sensor is in the sensor error state, generating a sensor error if the pulse output from the hall sensor is not in the sensor error state.

2. The method of claim 1, wherein the sensor error state defines that the pulse output from the hall sensor is within 6 pulses.

3. The method of claim 1, further comprising:
applying a sensor error disregard section to a respective end of sections of an operation of the motor;
checking whether or not a current position is between certain sections of an operation of the motor, when the seat is in a forward or backward displacement because the pulse, which is not in the sensor error state, is not output in during determine that the hall sensor is in an error state; and
when the current position is in the sensor error disregard section instead of being between the certain sections of operation of the motor and the pulse, which is not in the sensor error state, is output, setting the present position to be a limit position by disregarding the sensor error, and automatically determining an opposite limit position by applying a predetermined stroke distance.
